(19) United States
(12) Patent Application Publication
(10) Pub. No.: US 2025/0260092 A1
(43) Pub. Date: Aug. 14, 2025

(54) COOLING ASSEMBLY FOR BATTERY SYSTEM

(71) Applicant: Caterpillar Inc., Peoria, IL (US)

(72) Inventors: Brian Richard Bell, West Lafayette, IN (US); Krishna Prasath Ramabadhran, Krishnagiri (IN)

(73) Assignee: Caterpillar Inc., Peoria, IL (US)

(21) Appl. No.: 18/438,617

(22) Filed: Feb. 12, 2024

(51) Int. Cl. H01M 10/6568; H01M 10/613; H01M 50/209

(52) U.S. Cl. CPC H01M 10/6568; H01M 10/613; H01M 50/209

(57) ABSTRACT

A cooling assembly for a battery system includes an inlet system. The inlet system includes an inlet manifold, an inlet connecting tube, a first inlet connecting member defining a first surface and at least one first inlet fluid port, and a second inlet connecting member defining at least one second inlet fluid port in fluid communication with the at least one first inlet fluid port of the first inlet connecting member. The cooling assembly also includes an outlet system in fluid communication with the inlet system. The outlet system includes an outlet manifold, a first outlet connecting member defining at least one first outlet fluid port, an outlet connecting tube, and a second outlet connecting member defining at least one second outlet fluid port.

### TECHNICAL FIELD

The present disclosure relates to a battery system, and more particularly to, a cooling assembly for the battery system.

### BACKGROUND

Battery systems are used in a variety of applications as a means of power supply. For example, battery systems are being increasingly implemented in stationary and mobile machines, such as, passenger vehicles or construction machines, to supply operating power. In order to perform efficiently, battery modules of the such battery systems may have to be maintained and operated within predefined temperature limits to prevent overheating of the battery modules. Thus, all battery systems have a cooling system that supply a cooling fluid to maintain a temperature of the battery system within predefined temperature limits.

Battery systems vary in configuration based on the energy requirements of each application. For example, the battery system may have battery modules arranged in varying numbers of rows and columns. However, having a unique cooling system for each configuration increases a number of parts, inventory costs, and material costs for the cooling system. Moreover, such unique cooling systems may require longer lead time for manufacturing and assembly.

CN219801006U describes a battery liquid cooling structure and a battery pack, wherein the battery liquid cooling structure comprises at least one liquid cooling unit, the liquid cooling unit comprises a connecting pipe, a liquid inlet connector, a liquid outlet connector and at least two liquid cooling pipes for cooling a battery, the lengths of the liquid cooling pipes extend along a first direction, all the liquid cooling pipes are arranged at intervals along a second direction, the first direction and the second direction form an included angle, two adjacent liquid cooling pipes are at least communicated in parallel through two connecting pipes arranged at intervals, the liquid cooling pipes positioned at two sides of the second direction are respectively communicated with the liquid inlet connector and the liquid outlet connector, the connecting pipes on the liquid inlet connector and the liquid cooling pipes communicated with the liquid inlet connector are arranged at intervals along a set direction, and the connecting pipes on the liquid outlet connector and the liquid cooling pipes communicated with the liquid outlet connector are arranged at intervals along the set direction, and the set direction and the second direction form an included angle. The battery liquid cooling structure has low manufacturing cost, is convenient to assemble, and has high temperature uniformity for cooling the battery.

### SUMMARY OF THE DISCLOSURE

In an aspect of the present disclosure, a cooling assembly for a battery system is provided. The battery system includes at least one string of battery modules. The cooling assembly includes an inlet system. The inlet system includes an inlet manifold. The inlet system also includes an inlet connecting tube extending along a first central axis and coupled to the inlet manifold. The inlet system further includes a first inlet connecting member coupled to the inlet connecting tube and extending along the first central axis. The inlet connecting tube is disposed between the inlet manifold and the first inlet connecting member. The first inlet connecting member defines a first surface and at least one first inlet fluid port defined in the first surface. The inlet system includes a second inlet connecting member coupled to the first inlet connecting member at the first surface of the first inlet connecting member. The second inlet connecting member extends along a second central axis that is offset from and parallel to the first central axis. The second inlet connecting member defines at least one second inlet fluid port in fluid communication with the at least one first inlet fluid port of the first inlet connecting member. The cooling assembly also includes an outlet system in fluid communication with the inlet system. The outlet system includes an outlet manifold. The outlet system also includes a first outlet connecting member extending along a third central axis and coupled to the outlet manifold. The first outlet connecting member defines at least one first outlet fluid port. The outlet system further includes an outlet connecting tube coupled to the first outlet connecting member and extending along the third central axis. The first outlet connecting member is disposed between the outlet manifold and the outlet connecting tube. The outlet system includes a second outlet connecting member coupled to the outlet connecting tube and extending along the third central axis. The outlet connecting tube is disposed between the first outlet connecting member and the second outlet connecting member. The second outlet connecting member defines at least one second outlet fluid port.

In another aspect of the present disclosure, a battery system is provided. The battery system includes at least one string of battery modules. The battery system also includes a cooling assembly to direct cooling fluid towards the at least one string of battery module. The cooling assembly includes an inlet system. The inlet system includes an inlet manifold. The inlet system also includes an inlet connecting tube extending along a first central axis and coupled to the inlet manifold. The inlet system further includes a first inlet connecting member coupled to the inlet connecting tube and extending along the first central axis. The inlet connecting tube is disposed between the inlet manifold and the first inlet connecting member. The first inlet connecting member defines a first surface and at least one first inlet fluid port defined in the first surface. The inlet system includes a second inlet connecting member coupled to the first inlet connecting member at the first surface of the first inlet connecting member. The second inlet connecting member extends along a second central axis that is offset from and parallel to the first central axis. The second inlet connecting member defines at least one second inlet fluid port in fluid communication with the at least one first inlet fluid port of the first inlet connecting member. The cooling assembly also includes an outlet system in fluid communication with the inlet system. The outlet system includes an outlet manifold. The outlet system also includes a first outlet connecting member extending along a third central axis and coupled to the outlet manifold. The first outlet connecting member defines at least one first outlet fluid port. The outlet system further includes an outlet connecting tube coupled to the first outlet connecting member and extending along the third central axis. The first outlet connecting member is disposed between the outlet manifold and the outlet connecting tube. The outlet system includes a second outlet connecting member coupled to the outlet connecting tube and extending along the third central axis. The outlet connecting tube is disposed between the first outlet connecting member and the second outlet connecting member. The second outlet connecting member defines at least one second outlet fluid port.

Other features and aspects of this disclosure will be apparent from the following description and the accompanying drawings.

### BRIEF DESCRIPTION OF THE DRAWINGS

FIG. 1 is a diagrammatic representation of a battery system having a cooling assembly, according to an example of the present disclosure;

FIG. 2 is a schematic perspective view of an inlet system of the cooling assembly of FIG. 1, according to an example of the present disclosure;

FIG. 3 is a schematic perspective views of an inlet connecting tube and a first inlet connecting member of the inlet system of FIG. 2;

FIG. 4 is a schematic perspective view of a second inlet connecting member of the inlet system of FIG. 2;

FIG. 5 is a schematic sectional view illustrating a coupling of the second inlet connecting member of FIG. 4 with fluid lines in the battery system of FIG. 1;

FIGS. 6A to 6C illustrate different configurations for the inlet system based on a number of strings of battery modules associated with the battery system of FIG. 1;

FIG. 7 is a schematic perspective view of an outlet system of the cooling assembly of FIG. 1, according to an example of the present disclosure;

FIG. 8 is a schematic sectional view illustrating a first outlet connecting member of the outlet system of FIG. 7 with fluid lines in the battery system of FIG. 1; and

FIGS. 9A to 9C illustrate different configurations for the outlet system based on a number of strings of battery modules associated with the battery system of FIG. 1.

### DETAILED DESCRIPTION

Wherever possible, the same reference numbers will be used throughout the drawings to refer to the same or like parts.

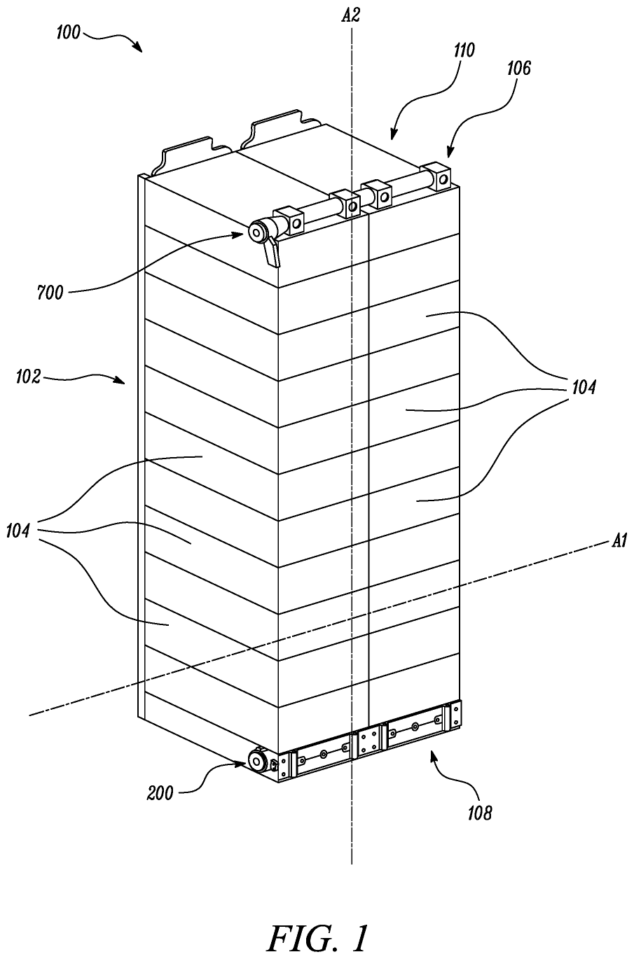

Referring to FIG. 1, a diagrammatic representation of an exemplary battery system 100 is illustrated. In some examples, the battery system 100 may be used in energy storage systems. In an example, the battery system 100 may supply electrical power to a moving machine, such as a work/construction machine, or a stationary machine.

The battery system 100 includes one or more strings 102 of battery modules 104. In the illustrated example of FIG. 1, the battery system 100 includes the single string 102 of battery modules 104. The single string 102 of battery modules 104 includes two rows of battery modules 104 disposed adjacent to each other along a horizontal axis A1. Furthermore, each row of the battery modules 104 includes eleven battery modules 104 herein that are stacked along a vertical axis A2 of the battery system 100. The battery modules 104 are electrically coupled together in a stacked relationship to provide a desired amount of power output and voltage output. It should be noted that the configuration of the battery system 100 as explained herein is exemplary in nature, and the battery system 100 may include two strings of battery modules, three strings of battery modules, four strings of battery modules, and so on, based on application requirements.

Each battery module 104 may include a number of rechargeable lithium-ion batteries to store electric power and distribute the stored electric power at a desired voltage and a desired amperage for desired applications. In other examples, each battery module 104 may include a number of rechargeable lead-acid batteries, nickel metal hydride (NiMH) batteries, and the like that converts chemical energy to electrical energy.

The battery system 100 includes a cooling assembly 106 to direct cooling fluid towards the one or more strings 102 of battery modules 104. The cooling fluid may include water, a combination of water and one or more chemicals, or any other type of cooling fluid. The cooling assembly 106 may be coupled to a thermal management system (not shown) of the battery system 100 to maintain a temperature of the battery system 100 within desired operating limits. The thermal management system may include, for example, a pump, a fluid vessel, valves, a controller, and the like. The cooling fluid enters the cooling assembly 106 via an inlet system 200 of the cooling assembly 106 and flows through the battery modules 104 to maintain the temperature of the battery system 100 within desired operating limits. Further, the cooling fluid, at a higher temperature, exits the cooling assembly 106 via an outlet system 700 of the cooling assembly 106.

As shown in FIG. 1, the inlet system 200 is disposed proximal to a bottom end 108 of the battery system 100 and the outlet system 700 is disposed proximal to a top end 110 of the battery system 100. As such, the cooling fluid flows upwards while flowing through the battery modules 104 of the battery system 100 before exiting the cooling assembly 106 via the outlet system 700. However, in other examples, the inlet system 200 may be disposed proximal to the top end 110 of the battery system 100 and the outlet system 700 may be disposed proximal to the bottom end 108 of the battery system 100.

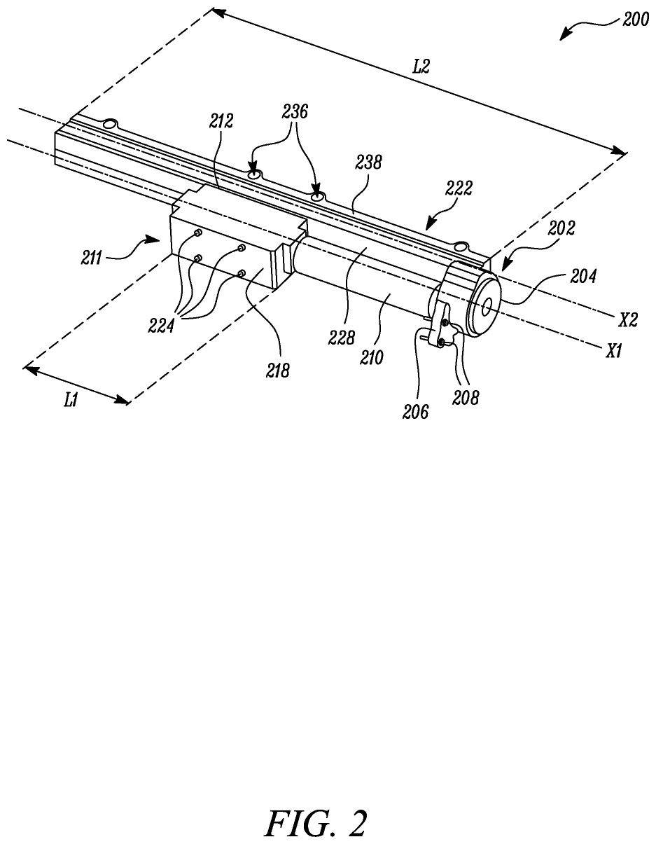

Referring to FIG. 2, the inlet system 200 includes an inlet manifold 202. The inlet manifold 202 is an interface between the thermal management system and the cooling assembly 106. The cooling fluid enters the cooling assembly 106 via the inlet manifold 202. The inlet manifold 202 includes a tubular member 204 and a bracket 206 to couple the inlet manifold 202 with the battery system 100 (see FIG. 1). A plurality of first fasteners 208 couple the inlet manifold 202 with the battery system 100. The first fasteners 208 may include bolts, pins, screws, and the like. In an example, the inlet manifold 202 may be made of a metallic material, such as, cast iron.

The inlet system 200 also includes an inlet connecting tube 210 extending along a first central axis X1 and coupled to the inlet manifold 202. The inlet connecting tube 210 is a tube that is in fluid communication with the tubular member 204 of the inlet manifold 202 to receive the cooling fluid therefrom.

The inlet system 200 further includes a first inlet connecting member 211 coupled to the inlet connecting tube 210 and extending along the first central axis X1. The first inlet connecting member 211 is in fluid communication with the inlet connecting tube 210 to receive the cooling fluid from the inlet connecting tube 210. The tubular member 204 of the inlet manifold 202, the inlet connecting tube 210, and the first inlet connecting member 211 are co-axial with each other and in fluid communication with each other. The inlet connecting tube 210 is disposed between the inlet manifold 202 and the first inlet connecting member 211. The first inlet connecting member 211 defines a first length L1 along the first central axis X1.

Further, the first inlet connecting member 211 is coupled with the inlet connecting tube 210 via a loose fit. In an example, a radial seal (not shown herein), such as an O-ring, may be disposed on an outer surface of the inlet connecting tube 210. Further, a portion of the inlet connecting tube 210 may be received within the first inlet connecting member 211, such that the radial seal is disposed between an inner surface of the first inlet connecting member 211 and the outer surface of the inlet connecting tube 210. The first inlet connecting member 211 has a rectangular shape. In an example, the first inlet connecting member 211 may be made of a metallic material, such as, aluminum.

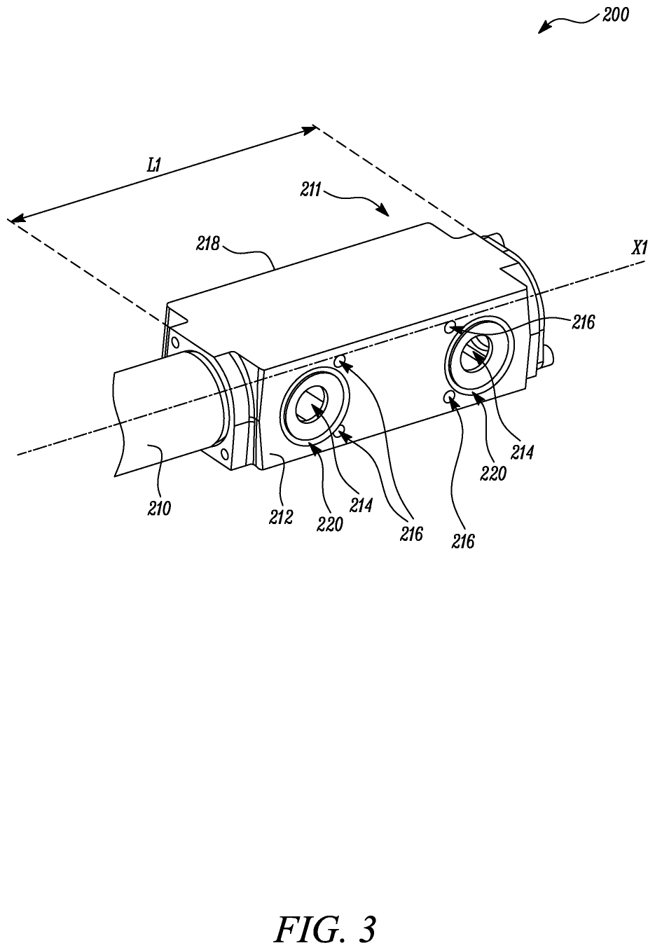

Referring now to FIG. 3, the first inlet connecting member 211 defines a first surface 212. The first inlet connecting member 211 also defines a surface 218 (shown in FIG. 2) opposite the first surface 212.

Further, the first inlet connecting member 211 defines one or more first inlet fluid ports 214 defined in the first surface 212. In the illustrated example of FIG. 3, the first inlet connecting member 211 defines two first inlet fluid ports 214. The first inlet fluid ports 214 extend in a direction that is orthogonal to the first central axis X1. The first surface 212 defines one or more circular grooves 220 that surround the one or more first inlet fluid ports 214. Specifically, the first surface 212 defines two circular grooves 220 that surround a corresponding first inlet fluid port 214. Further, the first surface 212 also defines a number of first apertures 216. The first surface 212 defines four first apertures 216 herein. The first apertures 216 are disposed proximate to the first inlet fluid ports 214.

The inlet system 200 includes a second inlet connecting member 222 coupled to the first inlet connecting member 211 at the first surface 212 of the first inlet connecting member 211. The inlet system 200 also includes a number of mechanical fasteners 224 to connect the first inlet connecting member 211 with the second inlet connecting member 222. The mechanical fasteners 224 further connect the first inlet connecting member 211 with the second inlet connecting member 222 with the battery system 100 (see FIG. 1). The mechanical fasteners 224 may include bolts, pin, screws, and the like.

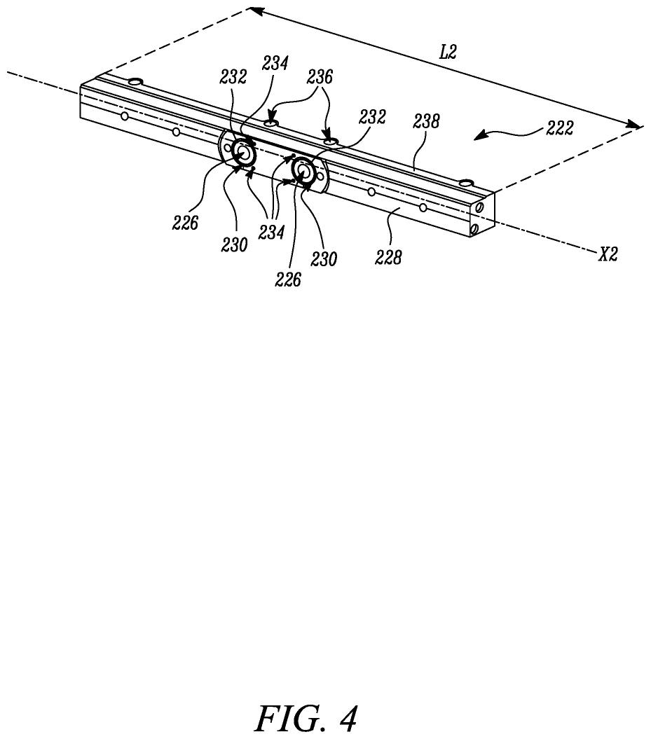

Referring now to FIGS. 2 and 4, the second inlet connecting member 222 extends along a second central axis X2 that is offset from and parallel to the first central axis X1. The second inlet connecting member 222 has a rectangular shape. In an example, the second inlet connecting member 222 may be made of a metallic material, such as, steel. The second inlet connecting member 222 defines a second length L2 along the second central axis X2. The second length L2 of the second inlet connecting member 222 is greater than the first length L1 of the first inlet connecting member 211.

As shown in FIG. 4, the second inlet connecting member 222 defines one or more second inlet fluid ports 226 in fluid communication with the one or more first inlet fluid ports 214 (see FIG. 3) of the first inlet connecting member 211 (see FIGS. 2 and 3). In the illustrated example of FIG. 4, the second inlet connecting member 222 defines two second inlet fluid ports 226. The second inlet fluid ports 226 extend in a direction that is orthogonal to the second central axis X2. The second inlet connecting member 222 receives the cooling fluid via the second inlet fluid ports 226.

Further, the second inlet connecting member 222 defines a second surface 228 in contact with the first surface 212 (see FIG. 3) of the first inlet connecting member 211. The second surface 228 defines the one or more second inlet fluid ports 226. The second surface 228 further defines one or more circular grooves 230 that surround the one or more second inlet fluid ports 226. Specifically, the second surface 228 defines two circular grooves 230 that surround a corresponding second inlet fluid port 226.

The second inlet connecting member 222 includes one or more sealing members 232 at least partially received within the one or more circular grooves 230 of the second surface 228 of the second inlet connecting member 222. Specifically, the second inlet connecting member 222 includes two sealing members 232, each of which is disposed within a corresponding circular groove 230. Further, a portion of the sealing members 232 is also received within the corresponding circular groove 220 (see FIG. 3) in the first inlet connecting member 211. The sealing member 232 is sandwiched between the second inlet connecting member 222 and the first inlet connecting member 211. In an example, the sealing member 232 may include a press and place seal having an annular shape.

Further, the second surface 228 also defines a number of second apertures 234. The second surface 228 defines four second apertures 234 herein. The second apertures 234 are disposed proximate to the second inlet fluid ports 226. The second apertures 234 are in alignment with corresponding first apertures 216 (see FIG. 3) in the first inlet connecting member 211 to receive the mechanical fasteners 224 (see FIG. 2) to connect the first inlet connecting member 211 with the second inlet connecting member 222.

Further, the second inlet connecting member 222 defines one or more third inlet fluid ports 236. The one or more third inlet fluid ports 236 is defined in a surface 238 of the second inlet connecting member 222 that is orthogonal to the second surface 228 of the second inlet connecting member 222. The second inlet connecting member 222 is in fluid communication with the one or more strings 102 (see FIG. 1) of battery modules 104 (see FIG. 1) via the one or more third inlet fluid ports 236. In the illustrated example of FIG. 4, the second inlet connecting member 222 defines two third inlet fluid ports 236. The third inlet fluid ports 236 extend in a direction that is orthogonal to the second central axis X2. Moreover, the third inlet fluid ports 236 and the second inlet fluid ports 226 extend orthogonal to each other. The third inlet fluid ports 236 direct the cooling fluid towards the battery modules 104.

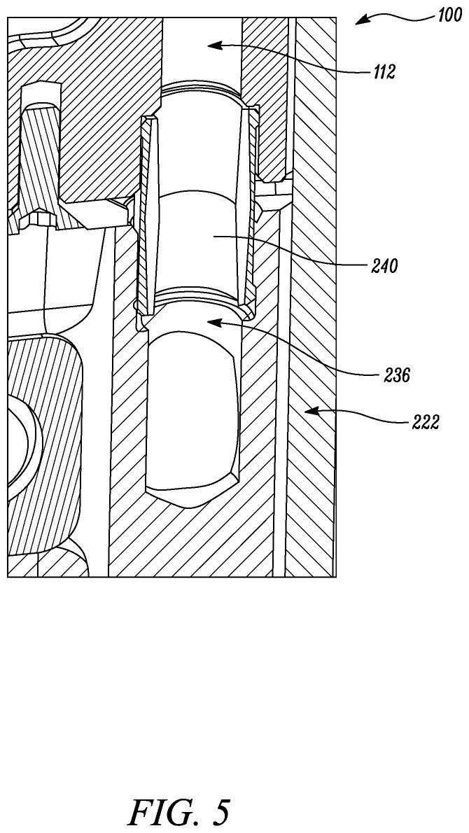

Referring now to FIG. 5, each third inlet fluid port 236 is coupled to a corresponding fluid line 112 in the battery system 100 via a corresponding first sealing element 240. The first sealing element 240 may be made of a polymer, such as, plastic and may have a rubber over molding. In an example, the first sealing element 240 may be manufactured by an injection molding process.

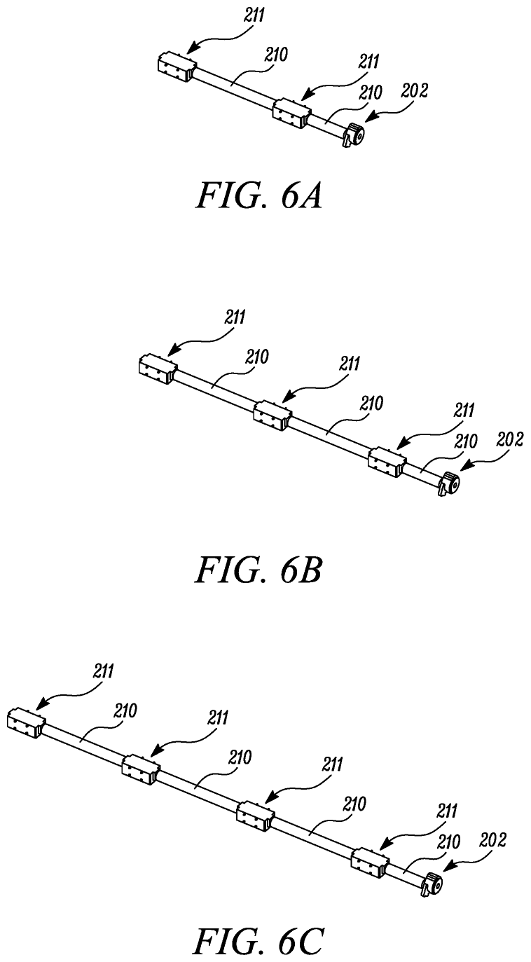

Referring now to FIGS. 6A to 6C, the inlet system 200 may include more than one inlet connecting tube 210, more than one first inlet connecting member 211, and more than one second inlet connecting member 222. As shown in FIGS. 6A to 6C, the inlet connecting tube 210 includes a number of inlet connecting tubes 210. Further, the first inlet connecting member 211 includes a number of first inlet connecting members 211. Furthermore, the second inlet connecting member 222 includes a number of second inlet connecting members 222. A total number of each of the number of inlet connecting tubes 210, the number of first inlet connecting members 211, and the number of second inlet connecting members 222 is based on a total number of strings of battery modules 104 (see FIG. 1) associated with the battery system 100 (see FIG. 1). However, the inlet system 200 will include only the single-common inlet manifold 202 irrespective of the total number of strings of battery modules 104.

As shown in FIG. 6A, when the battery system 100 (see FIG. 1) includes two strings of battery modules 104 (see FIG. 1), the inlet system 200 includes two inlet connecting tubes 210, two first inlet connecting members 211, and two second inlet connecting members 222. The two inlet connecting tubes 210 may be of same length or varying lengths based on design and dimensions of the battery system 100. Further, as shown in FIG. 6B, when the battery system 100 (see FIG. 1) includes three strings of battery modules 104 (see FIG. 1), the inlet system 200 includes three inlet connecting tubes 210, three first inlet connecting members 211, and three second inlet connecting members 222. The three inlet connecting tubes 210 may be of same length or varying lengths based on design and dimensions of the battery system 100. Furthermore, as shown in FIG. 6C, when the battery system 100 (see FIG. 1) includes four strings of battery modules 104 (see FIG. 1), the inlet system 200 includes two four inlet connecting tubes 210, four first inlet connecting members 211, and four second inlet connecting members 222. The four inlet connecting tubes 210 may be of same length or varying lengths based on design and dimensions of the battery system 100.

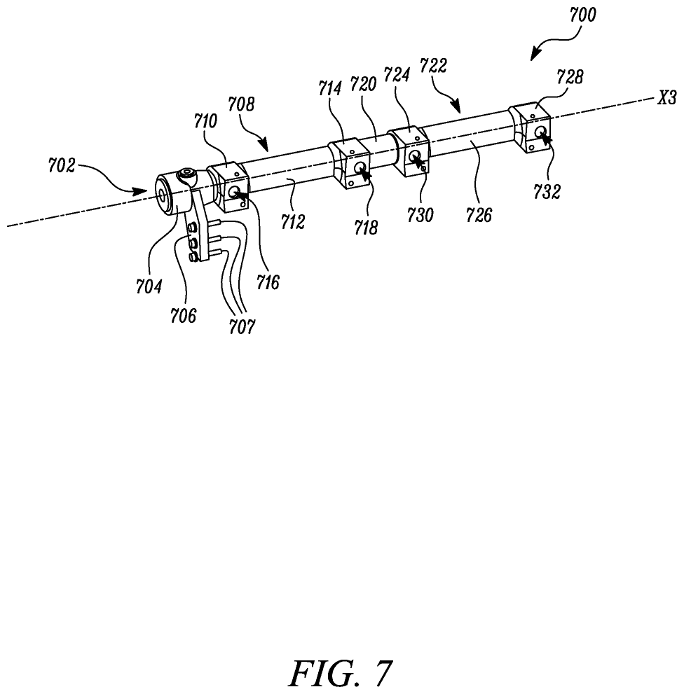

Referring now to FIG. 7, the cooling assembly 106 also includes the outlet system 700 in fluid communication with the inlet system 200. The outlet system 700 includes an outlet manifold 702. The cooling fluid at a higher temperature exits the cooling assembly 106 via the outlet manifold 702. The outlet manifold 702 includes a tubular member 704 and a bracket 706 that couples the outlet manifold 702 with the battery system 100 (see FIG. 1). A plurality of second fasteners 707 couple the outlet manifold 702 with the battery system 100. The second fasteners 707 may include bolts, pins, screws, and the like. In an example, the outlet manifold 702 may be made of a metallic material, such as, cast iron.

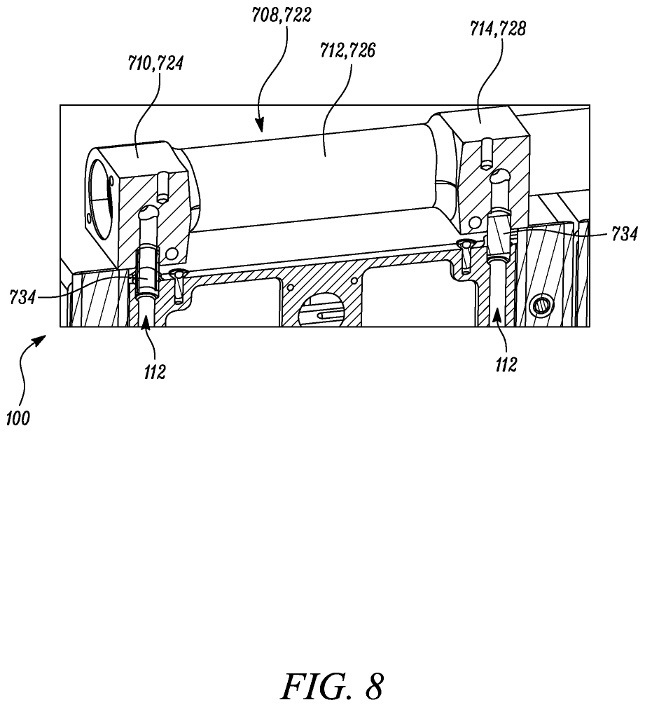

Referring to FIGS. 7 and 8, the outlet system 700 also includes a first outlet connecting member 708 extending along a third central axis X3 and coupled to the outlet manifold 702. The first outlet connecting member 708 is in fluid communication with the tubular member 704 of the outlet manifold 702 to receive the cooling fluid from the outlet manifold 702. In an example, the first outlet connecting member 708 may be made of a metallic material, such as, aluminum. The first outlet connecting member 708 includes a first bracket 710, a first tube member 712 integral with the first bracket 710, and a second bracket 714 integral with the first tube member 712. The first and second brackets 710, 714 are identical in shape and dimensions.

Further, the first outlet connecting member 708 defines one or more first outlet fluid ports 716, 718. In the illustrated example of FIGS. 7 and 8, the first outlet connecting member 708 includes two first outlet fluid ports 716, 718. The one or more first outlet fluid ports 716, 718 is defined in the first bracket 710 and/or the second bracket 714. Specifically, the first outlet fluid port 716 is defined in the first bracket 710 and the first outlet fluid port 718 is defined in the second bracket 714. The first outlet fluid ports 716, 718 extend orthogonal to the third central axis X3. The cooling fluid, that has a higher temperature after flowing through the battery modules 104 (see FIG. 1), is received within the first outlet connecting member 708 via the first outlet fluid ports 716, 718. Further, the first outlet connecting member 708 directs the cooling fluid towards the outlet manifold 702.

As shown in FIG. 7, the outlet system 700 further includes an outlet connecting tube 720 coupled to the first outlet connecting member 708 and extending along the third central axis X3. The first outlet connecting member 708 is disposed between the outlet manifold 702 and the outlet connecting tube 720. The outlet connecting tube 720 is in fluid communication with the first outlet connecting member 708. The outlet connecting tube 720 is embodied as a tube herein. In an example, the outlet connecting tube 720 may be made of a metallic material, such as, aluminum. Further, the first outlet connecting member 708 is coupled with the outlet connecting tube 720 via a loose fit. In an example, a radial seal (not shown herein), such as an O-ring may be disposed on an outer surface of the outlet connecting tube 720. Further, a portion of the outlet connecting tube 720 may be received within the first outlet connecting member 708 such that the radial seal is disposed between an inner surface of the first outlet connecting member 708 and the outer surface of the outlet connecting tube 720.

Referring to FIGS. 7 and 8, the outlet system 700 includes a second outlet connecting member 722 coupled to the outlet connecting tube 720 and extending along the third central axis X3. The outlet connecting tube 720 is disposed between the first outlet connecting member 708 and the second outlet connecting member 722. As such, the tubular member 704 of the outlet manifold 702, the first outlet connecting member 708, the outlet connecting tube 720, and the second outlet connecting member 722 are co-axial with each other and in fluid communication with each other. The second outlet connecting member 722 is similar in design and dimensions to the first outlet connecting member 708. In an example, the second outlet connecting member 722 may be made of a metallic material, such as, aluminum.

The second outlet connecting member 722 includes a third bracket 724, a second tube member 726 integral with the third bracket 724, and a fourth bracket 728 integral with the second tube member 726. The third and fourth brackets 724, 728 are identical in shape and dimensions.

The second outlet connecting member 722 defines one or more second outlet fluid ports 730, 732. In the illustrated example of FIGS. 7 and 8, the second outlet connecting member 722 includes two second outlet fluid ports 730, 732. The one or more second outlet fluid ports 730, 732 is defined in the third bracket 724 and/or the fourth bracket 728. Specifically, the second outlet fluid port 730 is defined in the third bracket 724 and the second outlet fluid port 732 is defined in the fourth bracket 728. The second outlet fluid ports 730, 732 extend orthogonal to the third central axis X3. The cooling fluid, that has a higher temperature after flowing through the battery modules 104 (see FIG. 1), is received within the second outlet connecting member 722 via the second outlet fluid ports 730, 732. Further, the second outlet connecting member 722 directs the cooling fluid towards the outlet manifold 702, via the first outlet connecting member 708 and the outlet connecting tube 720.

The second outlet connecting member 722 is coupled with the outlet connecting tube 720 via a loose fit. In an example, a radial seal (not shown herein), such as an O-ring may be disposed on the outer surface of the outlet connecting tube 720. Further, a portion of the outlet connecting tube 720 may be received within the second outlet connecting member 722 such that the radial seal is disposed between an inner surface of the second outlet connecting member 722 and the outer surface of the outlet connecting tube 720.

Referring now to FIG. 8, each of the first and second outlet fluid ports 716, 718, 730, 732 is coupled to the corresponding fluid line 112 in the battery system 100 via a corresponding second sealing element 734. The second sealing element 734 may be made of a polymer, such as, plastic and may have a rubber over molding. In an example, the second sealing element 734 may be manufactured by an injection molding process.

Referring now to FIGS. 2 and 7, each of the first inlet connecting member 211, the second inlet connecting member 222, the first outlet connecting member 708, and the second outlet connecting member 722 is manufactured by a casting process. Alternatively, each of the first inlet connecting member 211, the second inlet connecting member 222, the first outlet connecting member 708, and the second outlet connecting member 722 may be manufactured by any other technique, without any limitations.

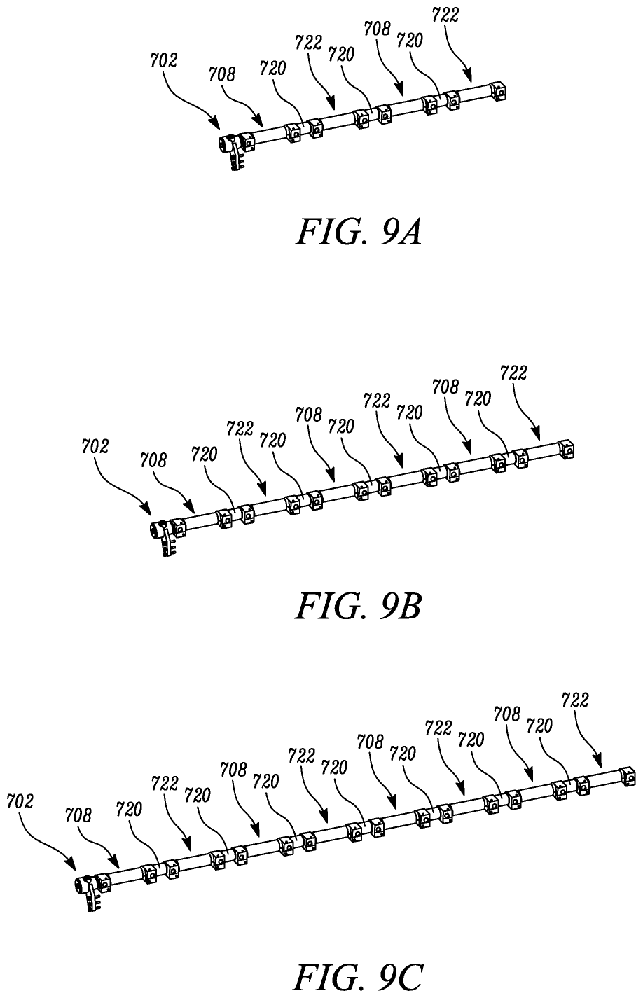

Referring to FIGS. 9A to 9C, the outlet system 700 may include more than one first outlet connecting member 708, more than one outlet connecting tube 720, and more than one second outlet connecting member 722. As shown in FIGS. 9A to C, the first outlet connecting member 708 includes a number of first outlet connecting members 708. Further, the outlet connecting tube 720 includes a number of outlet connecting tubes 720. Furthermore, the second outlet connecting member 722 includes a number of second outlet connecting member 722. A total number of each of the plurality of first outlet connecting members 708, the plurality of outlet connecting tube 720, and the plurality of second outlet connecting member 722 is based on a total number of strings of battery modules 104 (see FIG. 1) associated with the battery system 100 (see FIG. 1). However, the outlet system 700 will include only the single-common outlet manifold 702 irrespective of the total number of strings of battery modules 104.

As shown in FIG. 9A, when the battery system 100 (see FIG. 1) includes two strings of battery modules 104 (see FIG. 1), the outlet system 700 includes two first outlet connecting members 708, three outlet connecting tubes 720, and two second outlet connecting members 722. Further, as shown in FIG. 9B, when the battery system 100 (see FIG. 1) includes three strings of battery modules 104 (see FIG. 1), the outlet system 700 includes three first outlet connecting members 708, five outlet connecting tubes 720, and three second outlet connecting members 722. Furthermore, as shown in FIG. 9C, when the battery system 100 (see FIG. 1) includes four strings of battery modules 104 (see FIG. 1), the outlet system 700 includes four first outlet connecting members 708, seven outlet connecting tubes 720, and four second outlet connecting members 722.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### Industrial Applicability

The present disclosure relates to the cooling assembly 106 for the battery system 100. The cooling assembly 106 described herein has a simple design and may be assembled in a time-efficient manner. The cooling assembly 106 may be used with battery systems of different capacities. The cooling assembly 106 may be scalable based on a configuration, and more specifically, based on the total number of strings of battery modules 104 associated with the battery system 100. The scalable design of the cooling assembly 106 may reduce a number of parts, material costs, and inventory costs associated with the cooling assembly 106. Specifically, the cooling assembly 106 may be assembled using the same parts, in multiples, for different configurations or different battery system capacity. Furthermore, the cooling assembly 106 includes the single inlet manifold 202 and the single outlet manifold 702 that allows the cooling fluid to enter and exit the cooling assembly 106, respectively.

The first inlet connecting member 211 is coupled with the inlet connecting tube 210 via the radial seal, which may prevent leakage of the cooling fluid through an interface of the first inlet connecting member 211 and the inlet connecting tube 210. Further, the radial seal may also simplify an assembly process of the first inlet connecting member 211 with the inlet connecting tube 210. Moreover, each third inlet fluid port 236 of the second inlet connecting member 222 is coupled to the corresponding fluid line 112 in the battery system 100 via the corresponding first sealing element 240. The first sealing elements 240 may prevent leakage of the cooling fluid through an interface of the third inlet fluid port 236 and the corresponding fluid line 112, and may also simplify an assembly process of the second inlet connecting member 222 with the corresponding fluid line 112. The second inlet connecting member 222 also includes the sealing members 232 that seal the second inlet connecting member 222 with the first inlet connecting member 211, thereby preventing any leakage of the cooling fluid through an interface of the second inlet connecting member 222 and the first inlet connecting member 211.

Further, the first outlet connecting member 708 is coupled with the outlet connecting tube 720 via the radial seal, which may prevent leakage of the cooling fluid through an interface of the first outlet connecting member 708 and the outlet connecting tube 720. The radial seal may also simplify an assembly process of the first outlet connecting member 708 with the outlet connecting tube 720. Furthermore, the second outlet connecting member 722 is coupled with the outlet connecting tube 720 via the radial seal, which may prevent leakage of the cooling fluid through an interface of the second outlet connecting member 722 and the outlet connecting tube 720. The radial seal may also simplify an assembly process of the second outlet connecting member 722 with the outlet connecting tube 720.

Moreover, each of the first and second outlet fluid ports 716, 718, 730, 732 of the corresponding first and second outlet connecting members 708, 722 is coupled to the corresponding fluid line 112 in the battery system 100 via the corresponding second sealing element 734. The second sealing elements 734 may prevent leakage of the cooling fluid through an interface of the first and second outlet connecting members 708, 722 and the corresponding fluid line 112, and may also simplify an assembly process of the first and second outlet connecting members 708, 722 with the corresponding fluid line 112.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A cooling assembly for a battery system, the battery system including at least one string of battery modules, the cooling assembly comprising:
an inlet system including:
an inlet manifold;
an inlet connecting tube extending along a first central axis and coupled to the inlet manifold;
a first inlet connecting member coupled to the inlet connecting tube and extending along the first central axis, wherein the inlet connecting tube is disposed between the inlet manifold and the first inlet connecting member, and wherein the first inlet connecting member defines a first surface and at least one first inlet fluid port defined in the first surface; and
a second inlet connecting member coupled to the first inlet connecting member at the first surface of the first inlet connecting member, wherein the second inlet connecting member extends along a second central axis that is offset from and parallel to the first central axis, and wherein the second inlet connecting member defines at least one second inlet fluid port in fluid communication with the at least one first inlet fluid port of the first inlet connecting member; and
an outlet system in fluid communication with the inlet system, the outlet system including:
an outlet manifold;
a first outlet connecting member extending along a third central axis and coupled to the outlet manifold, wherein the first outlet connecting member defines at least one first outlet fluid port;
an outlet connecting tube coupled to the first outlet connecting member and extending along the third central axis, wherein the first outlet connecting member is disposed between the outlet manifold and the outlet connecting tube; and
a second outlet connecting member coupled to the outlet connecting tube and extending along the third central axis, wherein the outlet connecting tube is disposed between the first outlet connecting member and the second outlet connecting member, and wherein the second outlet connecting member defines at least one second outlet fluid port.

2. The cooling assembly of claim 1, wherein the inlet system further includes a plurality of mechanical fasteners to connect the first inlet connecting member with the second inlet connecting member.

3. The cooling assembly of claim 1, wherein the second inlet connecting member defines a second surface in contact with the first surface of the first inlet connecting member, wherein the second surface defines the at least one second inlet fluid port, and wherein the second surface defines at least one circular groove that surrounds the at least one second inlet fluid port.

4. The cooling assembly of claim 3, wherein the second inlet connecting member includes at least one sealing member at least partially received within the at least one circular groove of the second surface of the second inlet connecting member.

5. The cooling assembly of claim 3, wherein the second inlet connecting member further defines at least one third inlet fluid port, wherein the at least one third inlet fluid port is defined in a surface of the second inlet connecting member that is orthogonal to the second surface of the second inlet connecting member, and wherein the second inlet connecting member is in fluid communication with the at least one string of battery modules via the at least one third inlet fluid port.

6. The cooling assembly of claim 1, wherein the inlet connecting tube includes a plurality of inlet connecting tubes, wherein the first inlet connecting member includes a plurality of first inlet connecting members, wherein the second inlet connecting member includes a plurality of second inlet connecting members, and wherein a total number of each of the plurality of inlet connecting tubes, the plurality of first inlet connecting members, and the plurality of second inlet connecting members is based on a number of strings of battery modules associated with the battery system.

7. The cooling assembly of claim 1, wherein the first outlet connecting member includes a first bracket, a first tube member integral with the first bracket, and a second bracket integral with the first tube member, and wherein the at least one first outlet fluid port is defined in at least one of the first bracket and the second bracket.

8. The cooling assembly of claim 1, wherein the second outlet connecting member includes a third bracket, a second tube member integral with the third bracket, and a fourth bracket integral with the second tube member, and wherein the at least one second outlet fluid port is defined in at least one of the third bracket and the fourth bracket.

9. The cooling assembly of claim 1, wherein the first outlet connecting member includes a plurality of first outlet connecting members, wherein the outlet connecting tube includes a plurality of outlet connecting tubes, wherein the second outlet connecting member includes a plurality of second outlet connecting members, and wherein a total number of each of the plurality of first outlet connecting members, the plurality of outlet connecting tubes, and the plurality of second outlet connecting members is based on a number of strings of battery modules associated with the battery system.

10. The cooling assembly of claim 1, wherein each of the first inlet connecting member, the second inlet connecting member, the first outlet connecting member, and the second outlet connecting member is manufactured by a casting process.

11. A battery system comprising:
at least one string of battery modules; and
a cooling assembly to direct cooling fluid towards the at least one string of battery module, the cooling assembly including:
an inlet system including:
an inlet manifold;
an inlet connecting tube extending along a first central axis and coupled to the inlet manifold;
a first inlet connecting member coupled to the inlet connecting tube and extending along the first central axis, wherein the inlet connecting tube is disposed between the inlet manifold and the first inlet connecting member, and wherein the first inlet connecting member defines a first surface and at least one first inlet fluid port defined in the first surface; and
a second inlet connecting member coupled to the first inlet connecting member at the first surface of the first inlet connecting member, wherein the second inlet connecting member extends along a second central axis that is offset from and parallel to the first central axis, and wherein the second inlet connecting member defines at least one second inlet fluid port in fluid communication with the at least one first inlet fluid port of the first inlet connecting member; and
an outlet system in fluid communication with the inlet system, the outlet system including:
an outlet manifold;
a first outlet connecting member extending along a third second central axis and coupled to the outlet manifold, wherein the first outlet connecting member defines at least one first outlet fluid port;
an outlet connecting tube coupled to the first outlet connecting member and extending along the third central axis, wherein the first outlet connecting member is disposed between the outlet manifold and the outlet connecting tube; and
a second outlet connecting member coupled to the outlet connecting tube and extending along the third central axis, wherein the outlet connecting tube is disposed between the first outlet connecting member and the second outlet connecting member, and wherein the second outlet connecting member defines at least one second outlet fluid port.

12. The battery system of claim 11, wherein the inlet system further includes a plurality of mechanical fasteners to connect the first inlet connecting member with the second inlet connecting member.

13. The battery system of claim 11, wherein the second inlet connecting member defines a second surface in contact with the first surface of the first inlet connecting member, wherein the second surface defines the at least one second inlet fluid port, and wherein the second surface defines at least one circular groove that surrounds the at least one second inlet fluid port.

14. The battery system of claim 13, wherein the second inlet connecting member includes at least one sealing member at least partially received within the at least one circular groove of the second surface of the second inlet connecting member.

15. The battery system of claim 13, wherein the second inlet connecting member further defines at least one third inlet fluid port, wherein the at least one third inlet fluid port is defined in a surface of the second inlet connecting member that is orthogonal to the second surface of the second inlet connecting member, and wherein the second inlet connecting member is in fluid communication with the at least one string of battery modules via the at least one third inlet fluid port.

16. The battery system of claim 11, wherein the inlet connecting tube includes a plurality of inlet connecting tubes, wherein the first inlet connecting member includes a plurality of first inlet connecting members, wherein the second inlet connecting member includes a plurality of second inlet connecting members, and wherein a total number of each of the plurality of inlet connecting tubes, the plurality of first inlet connecting members, and the plurality of second inlet connecting members is based on a number of strings of battery modules associated with the battery system.

17. The battery system of claim 11, wherein the first outlet connecting member includes a first bracket, a first tube member integral with the first bracket, and a second bracket integral with the first tube member, and wherein the at least one first outlet fluid port is defined in at least one of the first bracket and the second bracket.

18. The battery system of claim 11, wherein the second outlet connecting member includes a third bracket, a second tube member integral with the third bracket, and a fourth bracket integral with the second tube member, and wherein the at least one second outlet fluid port is defined in at least one of the third bracket and the fourth bracket.

19. The battery system of claim 11, wherein the first outlet connecting member includes a plurality of first outlet connecting members, wherein the outlet connecting tube includes a plurality of outlet connecting tubes, wherein the second outlet connecting member includes a plurality of second outlet connecting members, and wherein a total number of each of the plurality of first outlet connecting members, the plurality of outlet connecting tubes, and the plurality of second outlet connecting members is based on a number of strings of battery modules associated with the battery system.

20. The battery system of claim 11, wherein each of the first inlet connecting member, the second inlet connecting member, the first outlet connecting member, and the second outlet connecting member is manufactured by a casting process.
